(19) United States
(12) Patent Application Publication
(10) Pub. No.: US 2006/0010646 A1
(43) Pub. Date: Jan. 19, 2006

(54) Low profile caster assembly

(76) Inventor: Dennis J. Bushey, East Troy, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/181,319

(22) Filed: Jul. 14, 2005

Related U.S. Application Data
(60) Provisional application No. 60/587,892, filed on Jul. 14, 2004.

(51) Int. Cl. B60B 33/00

(52) U.S. Cl. 16/35 R

(57) ABSTRACT

A low profile caster assembly is provided for facilitating movement of an object on a supporting surface. The low profile caster assembly includes a base having a central axis extending perpendicular thereto. The first caster wheel is operatively connected to the base and has a first side engageable with a supporting surface and a second side. The first caster wheel is rotatable about a first axis that is at an acute angle to the central axis through the base.

### CROSS-REFERENCE TO RELATED APPLICATIONS

This application claims the benefit of U.S. Provisional Application Ser. No. 60/587,892, filed Jul. 14, 2004.

### FIELD OF THE INVENTION

This invention relates generally to casters, and in particular, to a caster assembly with a low profile with respect to a supporting surface.

### BACKGROUND OF THE INVENTION

As is known, caster wheels are often interconnected to various objects such as furniture, file cabinets, luggage and the like to facilitate the movement of the item along a supporting surface. While these objects are often manufactured with the caster wheels already mounted thereon, the pre-mounting of the caster wheels on an object presents certain unique problems. For example, in order to safely ship an object after the caster wheels have been attached thereto, specialized packaging must be used in order to prevent the caster wheels from being knocked off the article during shipment. This, in turn, increases the overall expense of the article.

In view of the foregoing, specialized mounting brackets have been developed to allow for the caster wheels to be attached and/or removed from the bottom surface of the object after the manufacture thereof. While functional for their intended purpose, there are certain inherent problems with the mounting of the caster wheels to the bottom surface of an item. For example, given the weight of certain items such as furniture, the mounting of the caster wheels to the bottom surface thereof may be difficult. Further, when used in connection with heavy objects, it is possible for the caster wheels to be dislodged from the bottom surface of the object as the object is transported over a supporting surface. Finally, space considerations may limit the ability of a user to place the caster wheels under the object due to the height of the caster wheels.

Therefore, it is a primary object and feature of the present invention to provide a caster assembly that is mountable on the bottom surface of an object and that has a low profile with respect to a supporting surface on which the object rests.

It is a further object and feature of the present invention to provide a caster assembly that may be simply and easily connected to an object.

It is a still further object and feature of the present invention to provide a caster assembly that is mountable to the bottom surface of an object to allow the object to be transported over a supporting surface in a user desired direction.

In accordance with a present invention, a low profile caster assembly is provided. The low profile caster assembly including a base having a central axis extending generally perpendicular to the base. A first caster wheel is operatively connected to the base and has a first side engageable with a supporting surface and a second side. The first caster wheel is rotatable about a first axis that is at an acute angle to the central axis.

A first support is operatively connected to the base and is rotatable about the central axis. The first caster wheel is rotatably connected to the first support. A second caster wheel is operatively connected to the base and has a first side engageable with the supporting surface and a second side. The second caster wheel is rotatable about a second axis. It is contemplated for the second axis to be at an acute angle to the central axis. A second support is operatively connected to the base and is rotatable about the central axis. The second caster wheel is rotatably connected to the second support.

In accordance with a further aspect of the present invention, a low profile caster assembly is provided. The low profile caster assembly includes a generally flat base having a central axis extending generally perpendicular thereto. A first support is operatively connected to the base and is rotatable about the central axis. A first caster wheel is operatively connected to the first support and has a first side engageable with a supporting surface and a second side. The first caster wheel is rotatable about a first axis at a predetermined angle to the central axis.

The first axis may be generally parallel to the central axis or may be at an acute angle to the central axis. A second caster wheel is operatively connected to the base and has a first side engageable with the supporting surface and a second side. The second caster wheel is rotatable about a second axis. The second axis is at an acute angle to the central axis. A second support is operatively connected to the base and is rotatable about the central axis. The second caster wheel is rotatably connected to the second support.

In accordance with a still further aspect of the present invention, a low profile caster assembly. The low profile caster assembly includes a base having a central axis extending generally perpendicular thereto. A first support is operatively connected to the base. The first support is movable about the central axis along a first predetermined path. A first caster wheel is operatively connected to the first support and has a first side engageable with a supporting surface and a second side adjacent the first support. The first caster wheel is rotatable about a first axis at a predetermined angle to the central axis.

The first support has a generally flat first side directed toward the base and second side lying in a plane perpendicular to the first axis. The first axis is at an acute angle to the central axis. The low profile caster assembly may also include a second support operatively connected to the base and a second caster wheel. The second support is movable about the central axis along a second predetermined path. The second caster wheel is operatively connected to the second support and has a first side engageable with the supporting surface and a second side adjacent the second support. The second caster wheel is rotatable about a second axis at a predetermined angle to the central axis. It is contemplated for the second axis to be at an acute angle to the central axis. The first side of the first castor wheel has a generally flat central portion having a radially outer periphery and an angled portion extending radially from the outer periphery at an acute angle to the first axis.

### BRIEF DESCRIPTION OF THE DRAWINGS

The drawings furnished herewith illustrate a preferred construction of the present invention in which the above advantages and features are clearly disclosed as well as other which will be readily understood from the following description of the illustrated embodiment.

In the drawings:

FIG. 1 illustrates an isometric view of an object supported by a caster assembly in accordance with the present invention;

FIG. 2 schematically illustrates an exploded isometric to view of a first embodiment of a caster assembly shown in FIG. 1;

FIG. 3 schematically illustrates a detailed isometric top view of the caster assembly as shown in FIG. 2;

FIG. 4 schematically illustrates a partial cut-away first side elevation view of the caster assembly shown in FIG. 2;

FIG. 5 schematically illustrates a top view of the caster assembly shown in FIG. 2;

FIG. 6 schematically illustrates a second side elevation view of the caster assembly shown in FIG. 2;

FIG. 7 schematically illustrates a detailed isometric top view of another embodiment of a caster assembly in accordance with the present invention;

FIG. 8 schematically illustrates a partial cut-away first side elevation view of the caster assembly shown in FIG. 7;

FIG. 9 schematically illustrates a top view of the caster assembly shown in FIG. 7;

FIG. 10 schematically illustrates a second side elevation view of the caster assembly shown in FIG. 7;

FIG. 11 schematically illustrates a cut away view of a third embodiment of a caster assembly in accordance with the present invention;

FIG. 12 schematically illustrates a cut away view of a fourth embodiment of a caster assembly in accordance with the present invention;

FIG. 13 schematically illustrates an exploded isometric top view of a fifth embodiment of a caster assembly in accordance with the present invention;

FIG. 14 schematically illustrates an isometric top view of the caster assembly shown in FIG. 13;

FIG. 15 schematically illustrates a cutaway first side elevation view of the caster assembly shown in FIG. 13;

FIG. 16 a top view of the caster assembly illustrated in FIG. 13;

FIG. 17 schematically illustrates a second side elevation view of the caster assembly shown in FIG. 13;

FIG. 18 schematically illustrates a detailed isometric top view of a sixth embodiment of a caster assembly in accordance with the present invention;

FIG. 19 schematically illustrates a cutaway first side elevation view of the caster assembly shown in FIG. 18;

FIG. 20 schematically illustrates an isometric top view of the caster assembly shown in FIG. 18;

FIG. 21 schematically illustrates a second side elevation view of the caster assembly shown in FIG. 18;

FIGS. 22a-e illustrates various alternative embodiments of the caster assemblies in accordance with the present invention;

FIG. 23 is a bottom plan view of a still further embodiment of a caster assembly of the present invention in a first configuration;

FIG. 24 is a bottom plan view of the caster assembly of FIG. 23 in a second configuration;

FIG. 25 is an exploded view of a portion of the caster assembly of FIG. 23;

FIG. 26 is an exploded view of a first caster of the caster assembly of FIG. 23;

FIG. 27 is an exploded view of a second caster of the caster assembly of FIG. 23;

FIG. 28 is a cross-sectional view of the caster assembly of the present invention taken along line 28-28 of FIG. 23;

FIG. 29 is a cross-sectional view of the present invention taken along line 29-29 of FIG. 23;

FIG. 30 is a cross-sectional view of a caster assembly of the present invention taken along line 30-30 of FIG. 23;

FIG. 31 is a bottom plan view of a still further embodiment of the caster assembly of the present invention;

FIG. 32 is a side elevational view of a caster assembly of FIG. 31; and

FIG. 33 is a cross-sectional view of a caster assembly of the present invention taken along line 33-33 of FIG. 31.

### DETAILED DESCRIPTION OF THE PREFERRED EMBODIMENTS

A wide variety of loads could be constructed with the caster assembly in accordance with the present invention and as defined by the claims. Hence the preferred embodiments of the invention will be described with reference to an object, where the object can be a leg of an article of furniture, a file cabinet, a machinery, etc. and is not limiting on the invention.

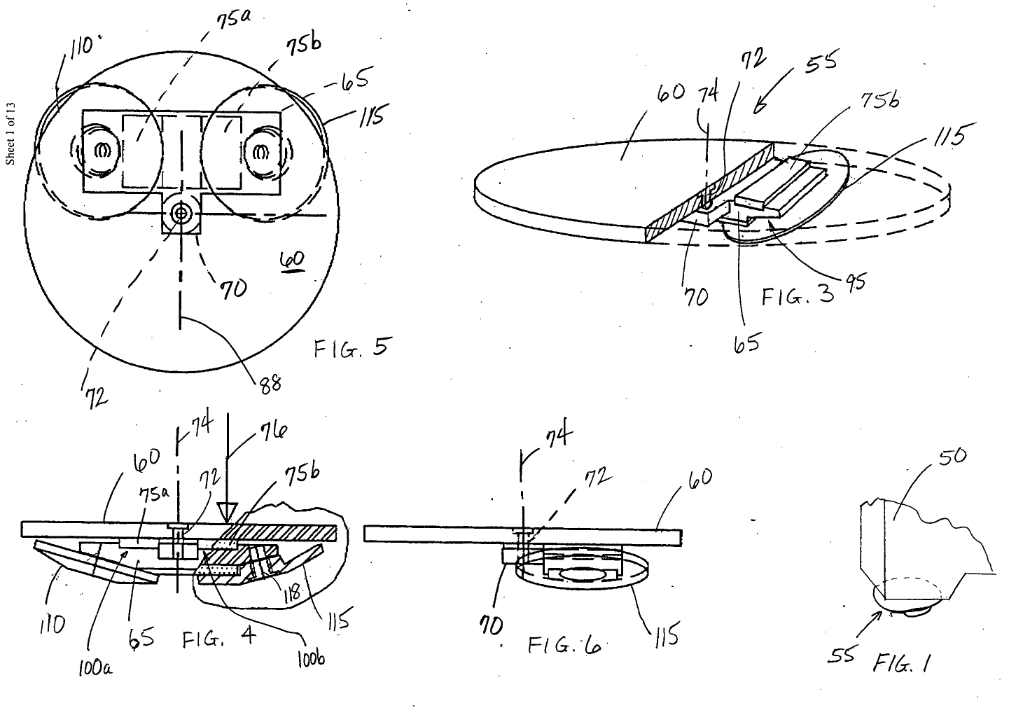

FIG. 1 schematically illustrates an object 50 supported on a first embodiment of a caster assembly 55 in accordance with the present invention. The caster assembly 55 is designed with a low profile and the ability to support heavy loads.

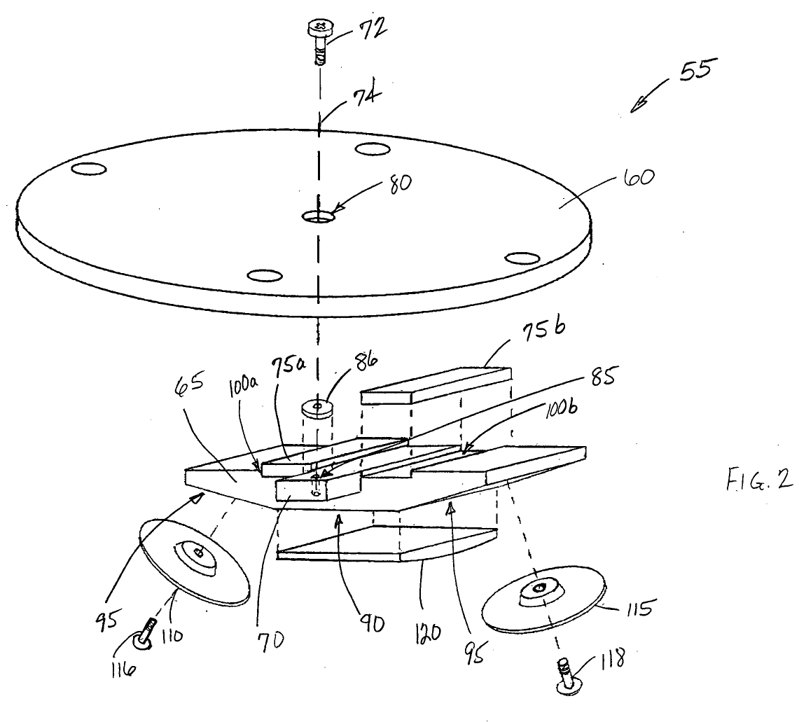

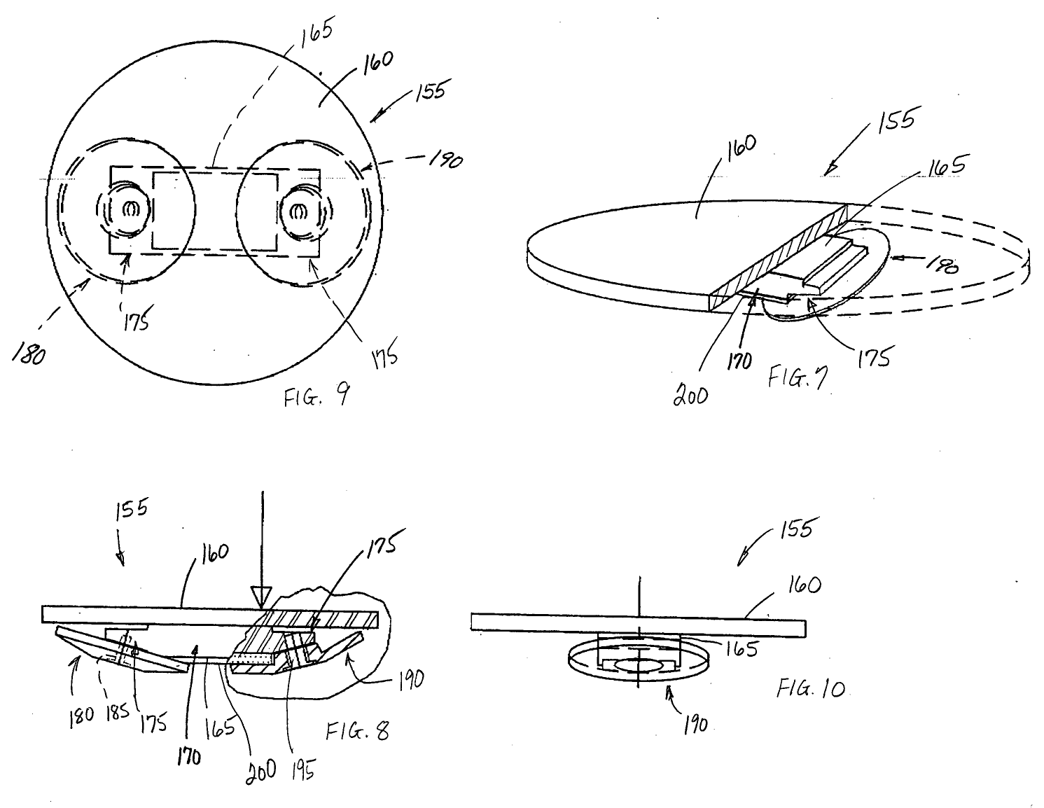

Referring now to FIGS. 2-6, the caster assembly 55 generally includes a swivel plate 60 in rotational support of a caster body 65. The swivel plate 60 can be attached to the object 50 by various known means (e.g., adhesive, screw fasteners, etc.) and is not limiting on the invention. The caster body 65 includes an offset portion 70 that is rotationally coupled by an axle 72 (e.g., screw, bolt, etc.) to the swivel plate 60. The offset portion 70 can be manufactured separately or integrated with the caster body 65. The offset portion 70 generally aligns the caster body 65 at an offset distance from a central axis 74 of the swivel plate 60. The illustrated axle 72 includes a threaded screw having a shoulder type head portion, but the type of axle (e.g., rivet, etc.) can vary. The swivel plate 60 can include a central bore or hole that is configured to counterbore the head portion of the axle 72 sufficient for a sliding fit to the object 50.

The caster assembly 55 further includes a first and a second swivel plate bushing 75a and 75b located between the caster body 65 and the swivel plate 60. Each swivel plate bushing 75a and 75b is preferably rectangular shaped, but the shape (e.g., rectangular, circular, etc.) of the swivel plate bushings 75a and 75b can vary. The swivel plate bushings 75a and 75b are comprised of low friction coefficient material that enhances rotation of the caster body 65 with respect to the swivel plate 60 under a load 76 associated with the object 50. The swivel plate 60 includes a first axle opening 80 and the offset portion 70 includes a second axle opening 85 to receive the axle 72. The caster assembly 55 can further include a washer 86 to reduce rotational friction between the offset portion 70 and the swivel plate 60. The axle 72 allows the caster body 65 to rotate 360 degrees in the horizontal plane with respect to the swivel plate 60. The illustrated offset portion 70 of the caster body 65 shows a threaded opening 85 configured to receive the axle 72, yet the opening 85 can otherwise be unthreaded to receive a rivet or the like.

The caster body 65 is generally rectangular shaped and is defined by a central longitudinal axis 88. The caster body 65 generally includes an inner region 90 of a first thickness and a pair of wing portion 95 that tapers to a second thickness that is less than the first thickness. The taper or angle of the wing portions 95 with respect to horizontal is generally shallow but can vary. The caster body 65 further includes a first and a second recessed portion 100a and 100b configured to receive the swivel plate bushings 75a and 75b, respectively.

Still referring to FIGS. 2-6, the caster assembly 55 further includes a first wheel 110 and a second wheel 115 each rotationally coupled by a first axle 116 and a second axle 118, respectively, to the caster body 65. The first wheel 110 is located on one side of the central longitudinal axis 88 of the caster body 65 and the second wheel 115 is located on the other side of the central longitudinal axis 88 opposite the first wheel 110. Each wheel 110 and 115 is mounted to the winged portions 95 of the caster body 65 such that the axles 116 and 118 that supports each wheel 110 and 115 is positioned at an angle with respect to vertical and that is associated to the taper or angle of the wing portions 95 with respect to horizontal.

The caster assembly 55 further includes a caster bushing 120 located between the caster body 65 and each wheel 110 and 115. The caster bushing 120 is illustrated as a single rectangular shaped, integrated piece having a generally curved outer surface and an inner portion that tapers to an outer end portion. The caster bushing 120 is attached to inner region 90 of the caster body 65 using various known fastening means (e.g., adhesives, screws, etc.).

The offset portion 70 of the caster assembly 55 allows the object 50 e.g., article of furniture, to be steered on the caster assembly 55 simply by applying a force at any angle in the plane of the swivel plate 60. The caster assembly 55 has the unique load bearing capability because the load is directly supported by a lamination of the swivel plate 60, the swivel plate bushings 75a and 75b, the caster body 65, the caster bushing 120 and the wheels 110 and 115 comprised of solid materials. Some of these materials have a low coefficient of friction, which allows each wheel 110 and 15 to move or rotate across the very broad low bearing surface. The individual loads on each axle 116 and 118 of each wheel 110 and 115 of the caster assembly 55 ranges from 0 to 20 percent of the total load of the object. The wheels 110 and 115 are placed at a shallow angle with respect to horizontal and in relationship to the floor. The shallow angle of the wheel assembly allows a smaller diameter of wheel to assume the floor contact of a much larger wheel. This feature allows the smaller caster assembly to bridge over cracks or rough surfaces that otherwise only a larger wheel caster assembly (not shown) is able to do.

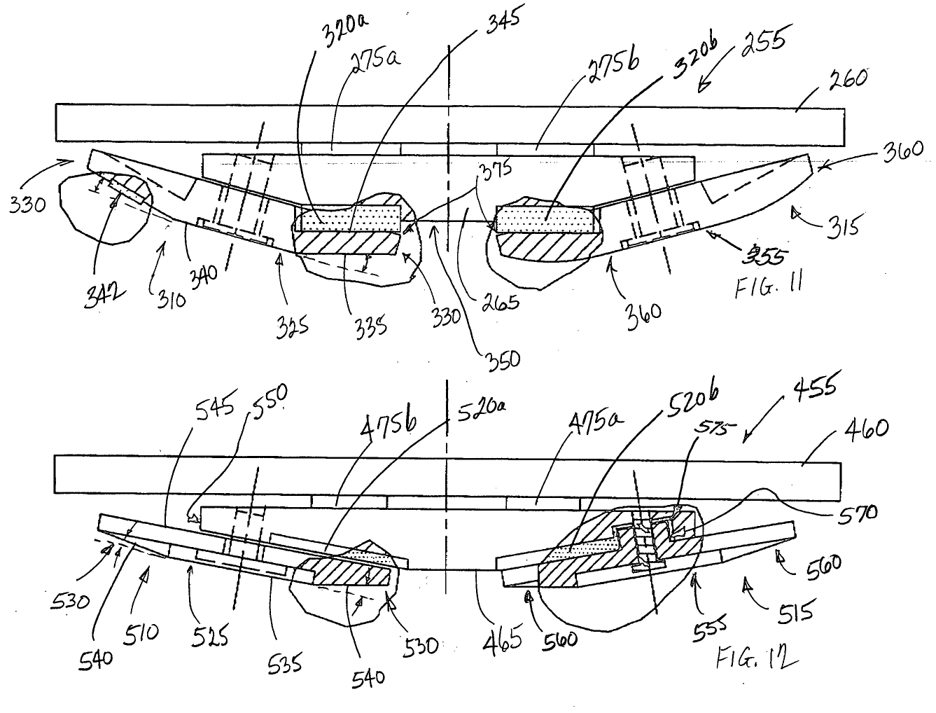

FIGS. 7-10 illustrate a second embodiment of a caster assembly 155 in accordance with the present invention. The caster assembly 155 generally includes a platform plate 160 configured to attach to an object (not shown) such as a leg of an article of furniture. In contrast to the caster assembly 55 described above, the caster assembly 155 includes a caster body platform 165 fixedly attached to the platform plate 160. Moreover, the caster body platform 165 is generally centrally position on the platform plate 160. The preferred caster body platform 165 includes an inner portion 170 having a first thickness and a pair of outer wing portions 175 having a second thickness less than the first thickness of the inner portion 170. Accordingly, the outer wing portion 175 is beveled at an angle with respect to horizontal. A first wheel 180 having first axle 185 and a second wheel 190 having a second axle 195 are rotationally mounted to the outer wing portions 175 of the caster body platform 165 in a manner similar to the wheels 100 and 115 described above. Accordingly, each wheel 180 and 190 is mounted at an angle with respect to vertical that is associated with the beveled angle of the outer wing portion 175 of the body platform 165. The caster assembly 155 further includes a platform bushing 200 disposed between the caster body platform 165 and the outer wing portion 175 of each wheel 180 and 190. The platform bushing 200 is comprised of low coefficient of friction material in a manner similar to the swivel plate bushing 75a and 75b and the caster bushing 120 described above.

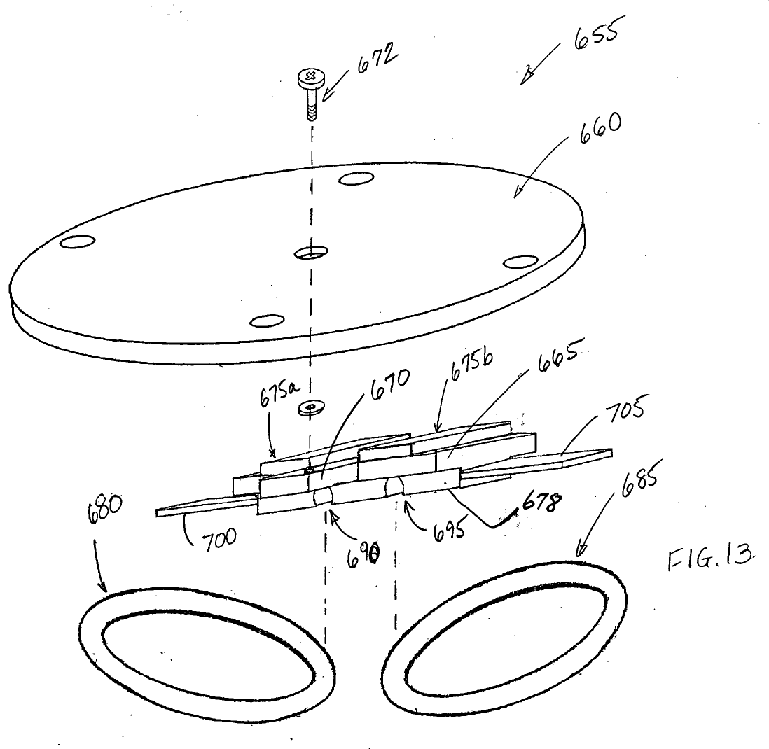

FIG. 11 illustrates an alternative embodiment of a caster assembly 255 having a swivel plate 260, a caster body 265, a swivel plate bushing 275a and 275b, a first wheel 310 and a second wheel 315, and a caster bushing 320 similar in construction to the caster assembly 55 described above. The first wheel 310 includes an inner radial portion or hub 325 having a first thickness and an outer radial portion 330 having a second thickness that is less than the first thickness of the inner radial portion 325. A lower surface 335 of the inner radial portion 325 is generally aligned at a shallow angle with respect to a lower surface 340 of the outer radial portion 330 such that a segment of the outer portion's lower surface 340 is in general horizontal alignment to engage in contact with a flat floor (not shown). The lower surface 340 of the outer radial portion 330 can further include a segment or strip 342 of material having a higher coefficient of friction relative thereto so as to enhance traction or reduce gouging of a floor surface. The upper surface 345 of the outer radial portion 330 of the wheel 310 is generally flat in engagement with the caster bushing 320 disposed between the wheel 310 and the caster body 260. The bushing 320 includes a first bushing strip 320a and a second bushing strip 320b that is generally horizontally aligned and flat in engagement between the upper surface 345 of the wheel 310 and an inner portion 350 of the caster body 260. The preferred second wheel 315 includes an inner radial portion 355 and an outer radial portion 360. However, a lower surface 365 of the outer radial portion 360 is generally curvilinear-shaped. The outer radial portions of the wheels 310 and 315 can further include a beveled edge 375 to enhance ease of rotation with respect to the bushing strips 320a and 320b.

FIG. 12 illustrates yet another alternative embodiment of a caster assembly 455 having a swivel plate 460, a caster body 465, a swivel plate bushing 475a and 475b, a first wheel 510 and a second wheel 515, and a caster bushing 520a and 520b similar in construction to the caster assembly 255 described above. The first wheel 510 includes an inner radial portion or hub 525 having a first thickness and an outer radial portion 530 having a second thickness that is tapered or beveled to a reduced thickness relative to the first thickness of the inner radial portion 525. An upper surface 545 of the inner radial portion 525 and outer radial portion 530 is generally flat. The lower surface 535 of the inner radial portion 525 is thus aligned at a shallow angle with respect to a lower surface 540 of the outer radial portion 530 such that a segment of the outer portion's lower surface 540 is in general horizontal alignment to engage in contact with a flat surface or floor (not shown). The caster bushings 520a and 520b are attached along a beveled outer radial portion 550 of the caster body 465 such that the caster bushings 520a and 520b are positioned at a shallow angle with respect to horizontal and in general flat alignment with the upper surface of the first wheel 510. The second wheel 515 is generally constructed with an inner radial portion 555 and a beveled outer radial portion 560 similar to the first wheel 510. However, the first wheel 515 further includes a hub 570 that is received in a recess 575 in the caster body 465. The hub 570 provides enhanced ability to absorb forces from right angles to the caster assembly 455.

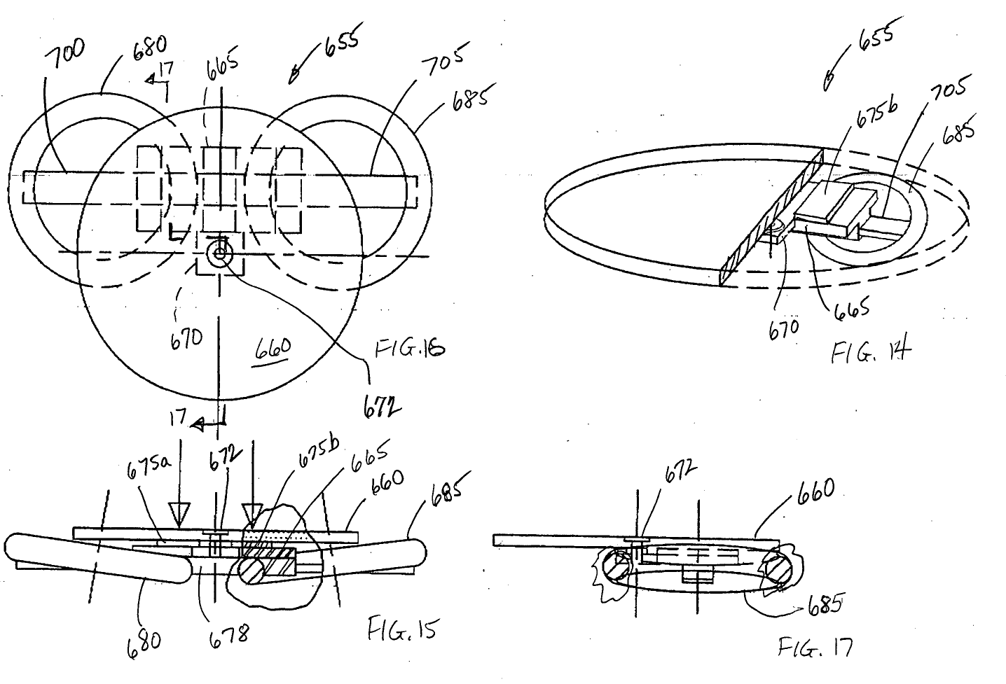

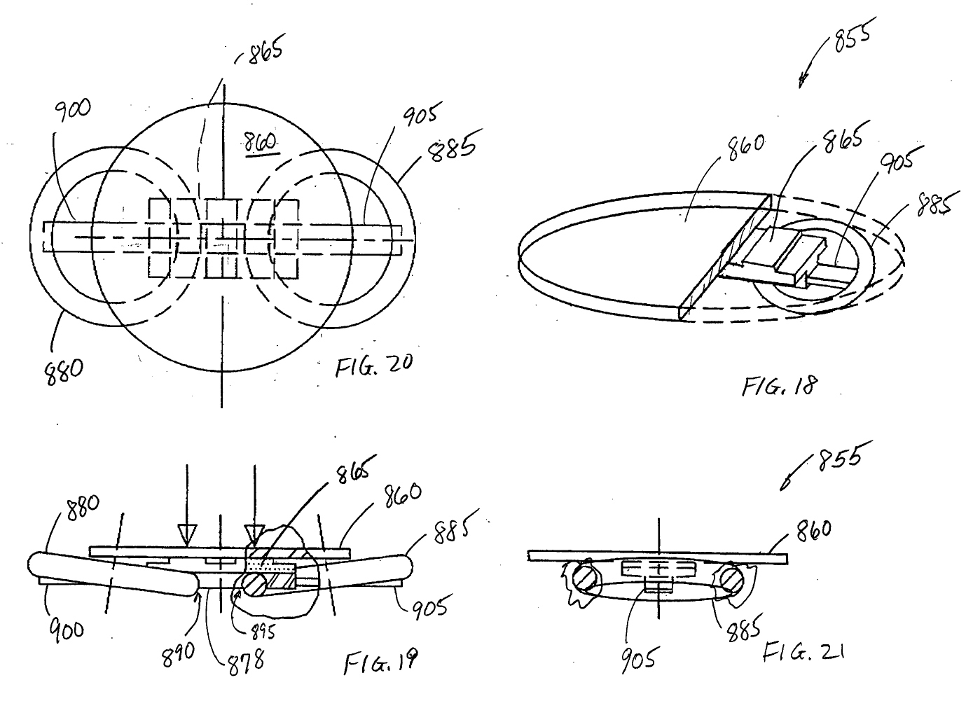

FIGS. 13-17 schematically illustrate yet another embodiment of a caster assembly 655 in accordance with the present invention. The caster assembly 655 generally includes a swivel plate 660 in support of a caster body 665, an offset portion 670, an axle 672, and a first and a second swivel plate bushing 675a and 675b, respectively, similar in construction to the caster assembly 55 shown in FIG. 2. However, instead of wheel assemblies 110 and 115, the caster assembly 655 includes a first ring 680 and a second ring 685. The caster assembly 655 further includes a caster bushing 678 attached to the caster body 665. The caster bushing 678 includes a first recess portion 690 to receive the first ring 680, and a second recess portion 695 to receive the second ring 685. The caster bushing 678, the caster body 665, and/or the swivel plate bushings 675a and 675b or combination thereof can be separate components or integrated as a single piece of the same material composition. The caster body 665 includes a first support arm 700 to couple the first ring 680 and a second support arm 705 to couple to the second ring 685 with the caster body 665. The recess portions 690 and 695 and the first and second support arms 700 and 705 are configured to snap engage the rings 680 and 685 and support the rings 680 and 685 each at an angle with respect to horizontal such that a portion or segment of each of the first and second rings 680 and 685 is engaged in contact with a flat surface (not shown), similar to the wheel assemblies 110 and 115 of the caster assembly 55 described above. The recessed portions 690 and 695 of the caster bushing are configured to receive the rings 680 and 685 in engagement with castor bushings 678, respectively. The general profile of the caster assembly 655 is such that it assumes floor contact similar to a larger wheel assembly (not shown).

FIGS. 18-21 illustrate yet another embodiment of a caster assembly 855 having a platform plate 860 fixed attached to a caster body platform 865, and a caster bushing 878, a first ring 880 and a second ring 885 in similar construction to the caster assembly 155 shown in FIG. 7. The caster assembly 855 further includes a first ring 880 and a second ring 885, similar to the caster assembly 655 described above. The caster bushing 878 includes a first recess 890 to receive the first ring 880, and a second recess 895 to receive the second ring 885. The caster body platform 865 includes a first support arm 900 and a second support arm 905. The first recess 890 and the first support arm support the first ring 880, and the second recess 895 and the second support arm 905 support the second ring 885 at an angle with respect to horizontal, similar in construction to the rings 680 and 685 of the caster assembly 655 described above. The caster body platform 865 is fixedly attached to the platform plate 860, and the caster body platform 865 is generally centrally mounted to the platform plate 860, similar to the caster assembly 155 described above.

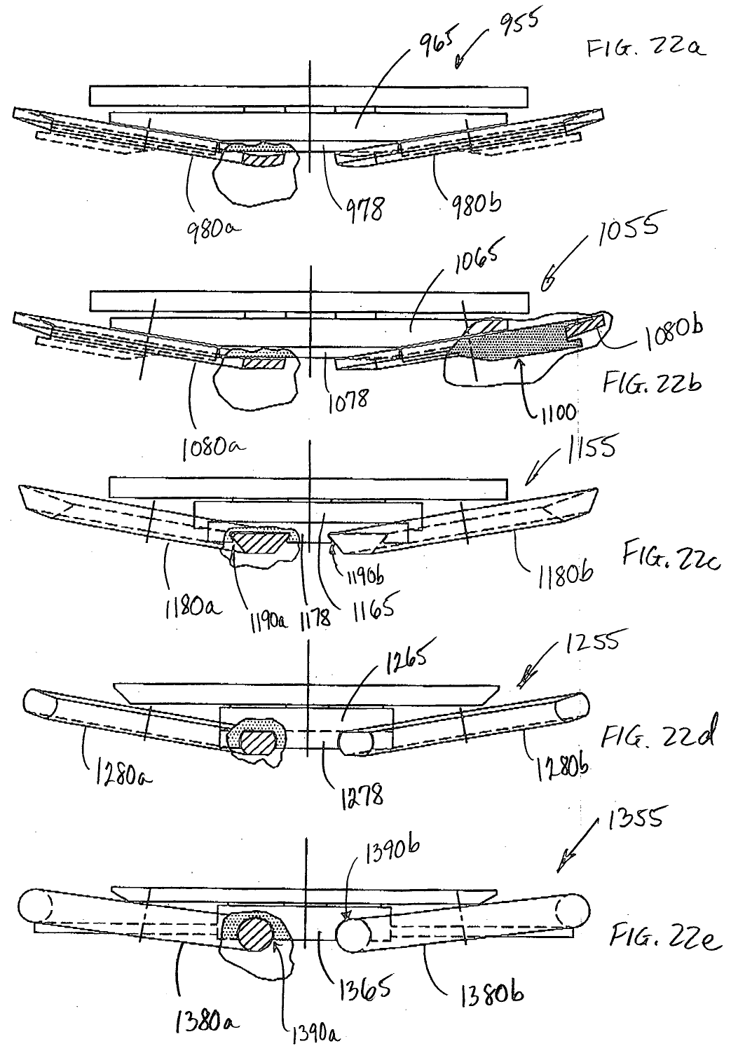

FIGS. 22a-22e generally illustrates various embodiments of caster assemblies having various shapes and profiles of a caster body, a caster bushing(s), and rings. FIG. 22a illustrates a caster assembly 955 having a caster body 965 with a generally trapezoidal-shaped cross-section supported on a generally horizontal aligned caster bushing 978. The caster assembly 955 is supported on rings 980a and 980b having a generally flat, curvilinear shaped profile. FIG. 22b illustrates a caster assembly 1055 having a caster body platform 1065 and a caster bushing 1078 supported on a pair of rings 1080a and 1080b. The rings 1080a and 1080b have a generally flat profile. The curvilinear shaped profile of the rings 980a and 980b allow the caster assembly 955 to roll easier relative to a caste assembly 1055 with the rings 1080a and 1080b having the flat profile because as a load may increase, the rings 980a and 980b flatten out, which increases the load carrying capacity of the caster assembly 955. FIG. 22b further illustrates the caster platform 1065 having a housing portion 1100 configured to support the rings 1080a and 1080b. The housing portion 1100 can be configured such that the rings 1080a and 1080b mount by snapping into position on the cast body platform 1065 or by using fasteners (not shown) to attach thereon. The caster body platform 1065, the caster bushing 1078, and/or the housing portion 1100 or combination thereof can be integrated and of the same material composition. FIG. 22c illustrates yet another embodiment of a caster assembly 1155 having a caster platform 1165 and/or bushing 1178 in support of a pair of rings 1180a and 1180b having a generally trapezoidal shaped profile. The caster platform 1165 and/or bushing 1178 is generally configured with recess portions 1190a and 1190b to receive the wider portion of the trapezoidal shaped profile of the rings 1180a and 1180b such that no additional supports or fasteners are needed to retain the rings 1180a and 1180b to the caster assembly 1155. The narrow portion of the profile of the rings 1180a and 1180b is configured to be in contact with a floor surface or the like. FIG. 22d illustrates yet another embodiment of a caster assembly 1255 having a caster body platform 1265, a caster bushing 1278 and a pair of rings 1280a and 1280b. The rings 1280a and 1280b include a generally barrel-shaped profile with a lower surface that is flat and a generally parallel alignment to engage the floor and a pair of curve linear shaped side portions that are retained by the caster body platform 1265 and/or the bushing 1278. FIG. 22e illustrates yet another embodiment of caster assembly 1355 having a caster body platform 1365 in support of a pair of rings 1380a and 1380b. The rings 1380a and 1380b include a generally circular-shaped profile that is retained in recess portions 1390a and 1390b, respectively, of the caster platform 1365. The FIGS. 22a-22e further illustrate that the recess portions of the various embodiments of the caster body platform and/or caster bushings described above can be various profiles to receive the various profiles of rings.

The swivel plate bushings and the caster bushings described above can comprise various materials of low friction characteristics such as plastic, oil saturated bronze, etc. The swivel plate bushings and caster bushings can be generally attached using various methods including adhesive, molded, encapsulated by body structure, etc. Moreover, the various embodiments of the swivel plate, the swivel plate bushing, and the caster bushings or combinations thereof can be of the same material composition as the caster body and is not limiting on the invention. Furthermore, the various components and/or combinations thereof the caster assemblies 55, 155, 255, 455, 655, 855, 1055, 1155, 1255, and 1355 described above can be separate components or integrated as a single piece of material composition and is not limiting on the invention.

Furthermore, one or more aspects and/or features of the embodiments of the caster assemblies 55, 155, 255, 455, 655, 855, 1055, 1155, 1255, and 1355 described above can be combined and/or interchanged with other aspects and features of the caster assemblies 55, 155, 255, 455, 655, 855, 1055, 1155, 1255, and 1355 and is not limiting on the invention.

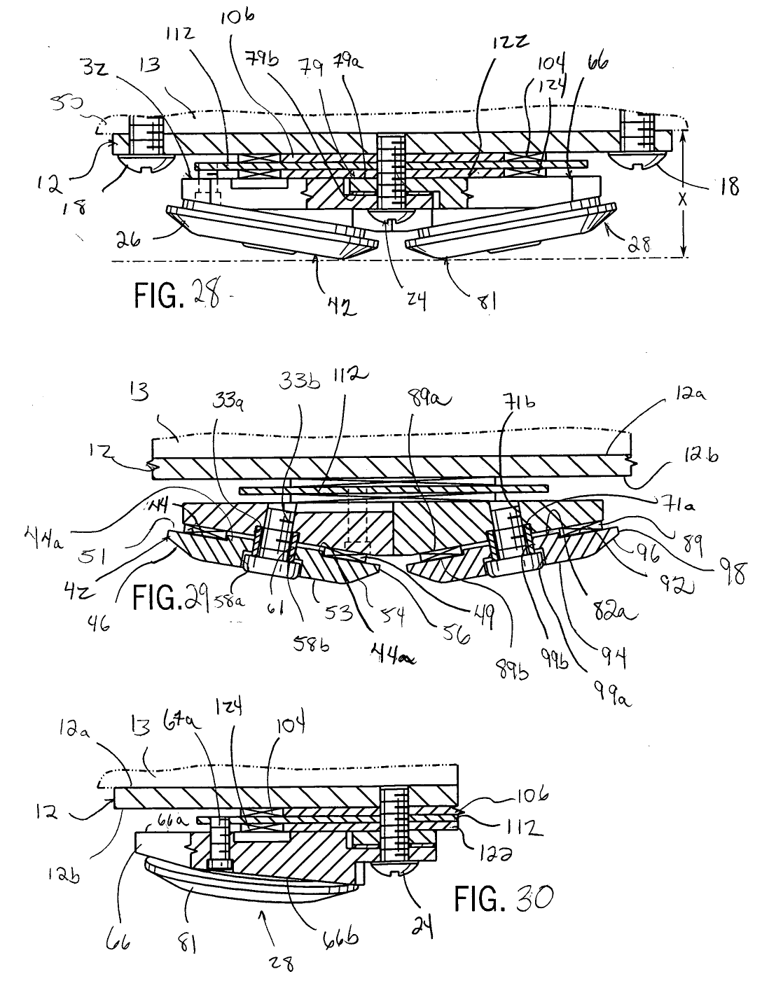

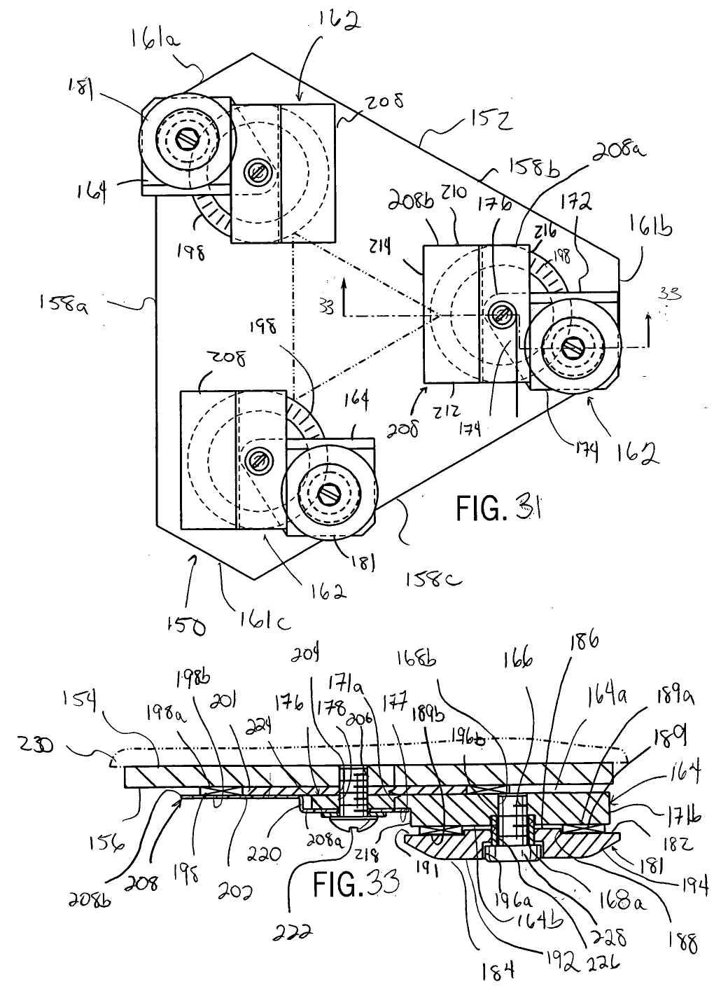

Referring to FIGS. 23-30, a further alternate embodiment of a caster assembly in accordance with the present invention is generally designated by the reference numeral 10. Caster assembly 10 includes a generally flat support plate 12 defined by upper and lower surfaces 12a and 12b, respectively, and outer peripheral edge 14. Support plate 12 includes a plurality of circumferentially spaced apertures extending between upper face 12a and lower face 12b thereof adjacent outer peripheral edge 14. Apertures 16 are adapted to receive corresponding fasteners, such as screws 18, therethrough in order to connect support plate 12 to object 13, FIGS. 28-30, such as an article of furniture, file cabinet, piece of machinery or the like. It can be appreciated that other types of fasteners such as adhesive or nails may be used to interconnect support plate 12 to object 13 without deviating from the scope of the present invention. Support plate 12 further includes a central aperture 20 extending along an axis 22 generally perpendicular to support plate 12. Central aperture 20 through support plate 12 is adapted to receive screw 24, for reasons hereinafter described.

Caster assembly 10 further includes first and second caster wheel assemblies 26 and 28, respectively. Referring to FIG. 26, first caster wheel assembly 26 includes support member 32 having a generally flat upper face 32a and an angled lower surface 32b, for reasons hereinafter described. Central aperture 33 extends between upper face 32a and lower face 32b along axis 37 and includes an enlarged diameter portion 33a and a reduced diameter portion 33b, FIG. 29. It is contemplated for angled lower face 32b of support member 32 to lie in a plane at a predetermined angle to axis 22. Support member 32 further includes first and second side surfaces 33a and 33b, respectively, interconnected by a generally flat stop surface 34 and an end surface 35. Stop surface 34 extends between upper and lower faces 32a and 32b, respectively, and has a concave recessed surface 36 provided in a first end thereof. A generally cylindrical shaped ear 38 projects laterally from recessed surface 36. Ear 38 includes upper and lower surfaces 38a and 38b, respectively, and a central aperture 40 extending therebetween.

Caster wheel assembly 26 further includes caster wheel 42 having an upper surface 44 and a lower surface 46. Upper surface 44 of caster wheel 42 includes a generally cylindrical neck portion 44a projecting therefrom and dimensioned for receipt within a corresponding central opening 48 in bearing ring 49. Bearing ring 49 facilitates rotation of caster wheel 42 about central axis 37, as hereinafter described. Upper surface 44 of caster wheel 42 further includes a generally flat outer ring portion 51 adapted for engagement with lower surface 49b of bearing ring 49. Lower surface 46 of caster wheel 42 includes a generally flat central portion 53 and an angled portion 54 extending radially from the outer periphery of central portion 53 to outer edge 56 of caster wheel 42. Caster wheel 42 further includes a central aperture 58 extending along axis 37 having an enlarged diameter portion 58a that communicates with lower surface 46 of caster wheel 42 and a reduced diameter portion 58b that communicates with upper surface 44 of caster wheel 42.

In order to assemble first caster wheel assembly 26, upper surface 49a of bearing ring 49 is positioned against lower face 32b of support member 32 and neck portion 44a of upper surface 44 of caster wheel 42 is inserted into central opening 48 through bearing ring 49. As described, central aperture 33 through support member 32 and central aperture 58 through caster wheel are coaxial along axis 37. Tubular bushing 61 is inserted into reduced diameter portion 58b of opening 58 through caster wheel 42 and into enlarged portion 33a of central opening 33 through support member 32. The shaft of screw 63 extends through bushing 61 and is threaded into the reduced diameter portion 33b of central opening 33 through support member 32 such that the head of screw 63 becomes seated in the enlarged diameter portion 58a of central opening 58 through caster wheel 42. As described, caster wheel 42 is free to rotate about axis 37 extending through central opening 58 through caster wheel 42 and through central opening 33 through support member 32.

Referring to FIG. 27, second caster wheel assembly 28 includes support member 66 having a generally flat upper face 66a and an angled lower surface 66b, for reasons hereinafter described. Central opening 68 and first and second mounting apertures, 67a and 67b, respectively, extend between upper face 66a and lower face 66b. Central opening 68 extends along axis 69 and includes an enlarged diameter portion 71a and a reduced diameter portion 71b. It is contemplated for angled lower face 66b of support member 66 to lie in a plane at a predetermined angle to axis 22. Support member 66 further includes first and second side surfaces 72a and 72b, respectively, interconnected by a generally flat stop surface 74a and an end surface 76a. Stop surface 74a extends between upper and lower faces 66a and 66b, respectively, and has a concave recessed surface 78 provided in a first end thereof. A generally cylindrical shaped ear 79 projects laterally from recessed surface 78. Ear 79 includes upper and lower surfaces 79a and 79b, respectively, and central aperture 83 extending therebetween.

Second caster wheel assembly 28 further includes caster wheel 81 having an upper surface 82 and a lower surface 84, FIG. 29. Neck portion 82a projects from upper surface 82 of caster wheel 81 and is dimensioned for receipt within a corresponding central opening 87 in bearing ring 89. Bearing ring 89 facilitates rotation of caster wheel 81 about central axis 69, as hereinafter described. Upper surface 82 of caster wheel 81 further includes a generally flat outer ring portion 92 adapted for engagement with lower surface 89b of bearing ring 89. Lower surface 84 of caster wheel 81 includes a generally flat central portion 94 and an angled portion 96 extending radially from the outer periphery of central portion 94 to the outer edge 98 of caster wheel 81. Caster wheel 81 further includes a central opening 99 extending along axis 69 that has an enlarged diameter portion 99a that communicates with lower surface 84 of caster wheel 81 and a reduced diameter portion 99b that communicates with upper surface 82 of caster wheel 81.

In order to assemble second caster wheel assembly 28, upper surface 89a of bearing ring 89 is positioned against lower face 66b of support member 66 and neck portion 82a of upper surface 82 of caster wheel 81 is inserted into central opening 87 through bearing ring 89. As described, central aperture 68 through support member 66 and central opening 99 through caster wheel 81 are coaxial with axis 69. Tubular bushing 101 is inserted into reduced diameter portion 99b of central opening 99 through caster wheel 81 and into enlarged portion 71a of central aperture 68 through support member 66. The shaft of screw 102 extends through bushing 101 and is threaded into the reduced diameter portion 71b of central aperture 68 through support member 66 such that the head of screw 102 becomes seated in the enlarged diameter portion 99a of central opening 99 through caster wheel 81. As described, caster wheel 81 is free to rotate about axis 69 extending through central opening 99 through caster wheel 81 and through central opening 68 through support member 66.

Referring back to FIG. 25, caster assembly 10 is assembled by positioning of upper surface 104a of bearing ring against lower surface 12b of support plate 12. Upper alignment disc 106 is received within central opening 108 of bearing disc 104 such that aperture 106a through alignment disc 106 is aligned with central opening 20 through support plate 12. Central opening 112a in swivel plate 112 is aligned with central opening 106a through alignment disc 106. Upper surface 114a of swivel plate 112 is positioned such that it engages lower surface 104b of bearing ring 104. Central opening 122a of lower alignment disc 122 is aligned with central opening 112a through swivel plate 112. Lower alignment disc 122 is positioned such that upper surface 124a of lower alignment disc 122 abuts lower surface 114b of swivel plate 112. Bearing ring 124 is positioned about the outer periphery 126 of lower alignment disc 122 such that upper surface 124a of bearing ring 124 engages lower surface 114b of swivel plate 112. Upper face 32a of support member 32 is positioned against lower surface 124b of bearing ring 124 such that central opening 40 through ear 38 is aligned with central opening 122a through lower alignment plate 122. Washer 128 is positioned against lower surface 38b of ear 38 such that opening 128a through washer 128 is aligned with central opening 40 through ear 38. Upper surface 79a of ear 79 is positioned against washer 128 such that central opening 83 through ear 79 is aligned with opening 128a through washer 128. Screw 24 extends through central opening 83 through ear 79; through opening 128a in washer 128; through central opening 40 in ear 38, through central opening 122a in lower alignment plate 122; through central opening 112a in swivel plate 112; through central opening 106a in upper alignment disc 106; and into central opening 20 of support plate 12 so as to interconnect the various components of caster assembly 10. It is contemplated to interconnect second caster wheel assembly 28 to swivel plate 112 by means of bolts 130a and 130b, respectively, that extend through corresponding mounting apertures 67a and 67b, respectively, in support member 66 and into corresponding threaded openings 132a and 132b, respectively, in swivel plate 112.

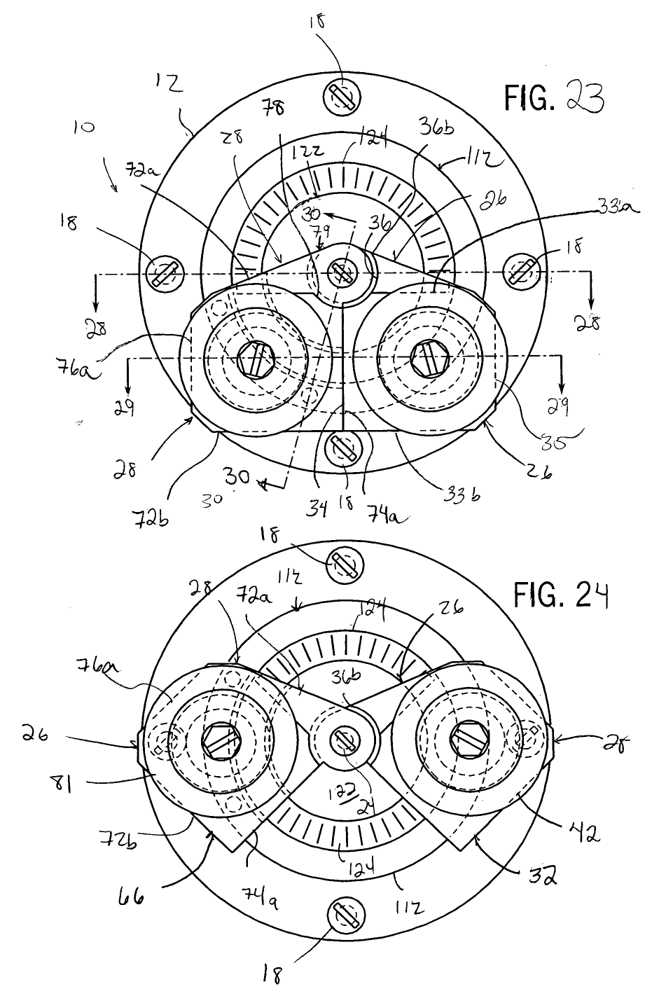

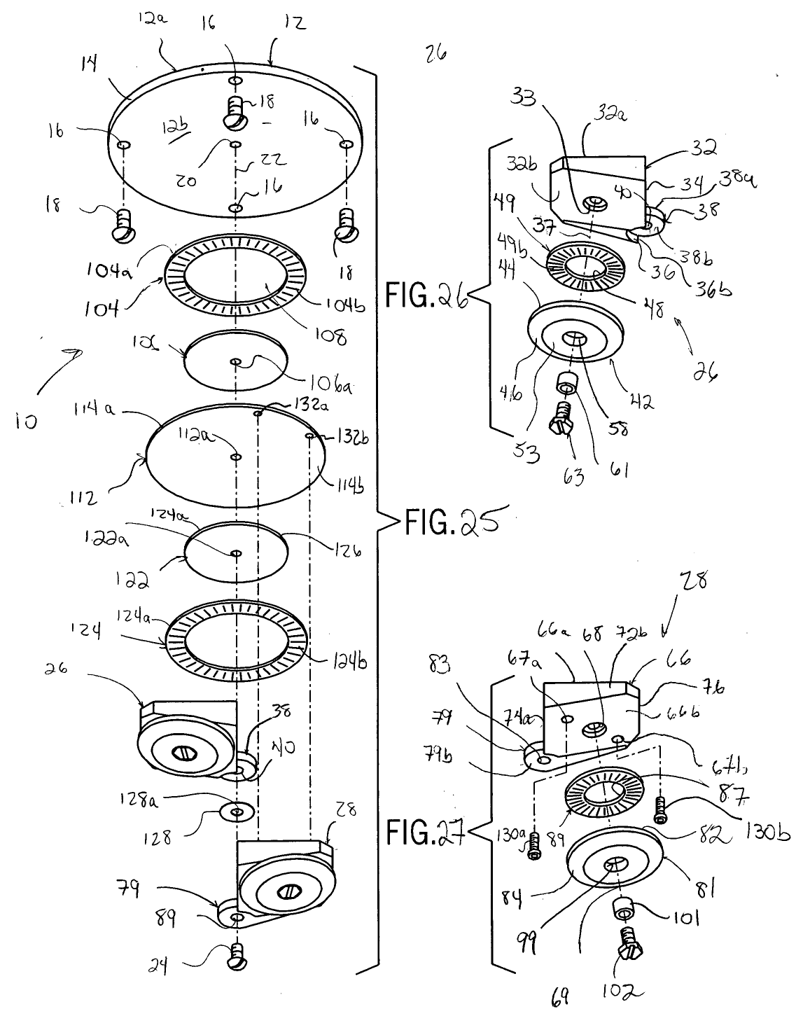

Once assembled, caster assembly 10 may be mounted to object 13 such as an article of furniture, file cabinet, piece of machinery or the like by screws 18 extending through support plate 12. As described, swivel plate 12 revolves around axis 22 on bearing ring 104. As such, second caster wheel assembly 28 rotates with swivel plate 112 about axis 22. In addition, first caster wheel assembly 26 may also rotated about axis 22 between the first position, FIG. 23, wherein stop surface 34 of support member 32 of first caster wheel assembly 26 engages stop surface 74a of support member 66 of second caster wheel assembly, and a second position, FIG. 24, wherein terminal edge 36b of recess surface 36 of support member 32 of first caster wheel assembly 26 engages first side surface 72a of support member 66 of second caster wheel assembly 28. As described, it can be appreciated that caster assembly 10 facilitates the movement of object 13 over a supporting surface or the like.

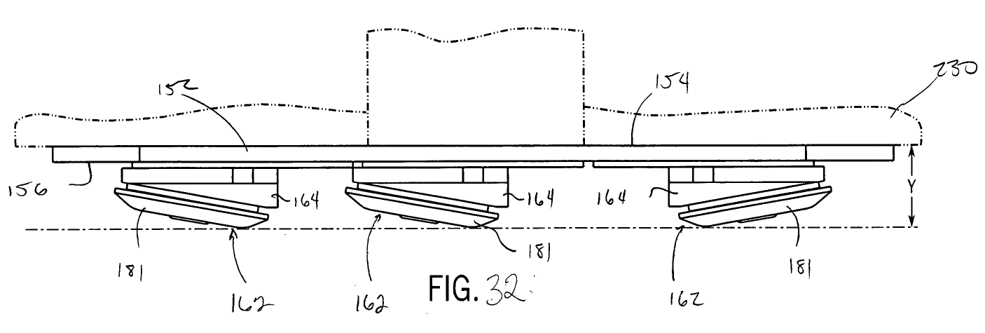

Referring to FIGS. 31-33, a still further embodiment of the caster assembly in accordance with the present invention is generally designated by the reference numeral 150. Caster assembly 150 includes a generally flat, triangular support plate generally designed by the reference numeral 152. Support plate is defined by a generally flat upper surface 154 and a generally flat lower surface 156. The outer periphery of support plate 152 is partially defined by sides 158a, 158b and 158c. Sides 158a and 158b are interconnected by corner 161a. Sides 158b and 158c are interconnected by corner 161b. Sides 158c and 158a are interconnected by corner 161c. Caster assemblies 162 are interconnected to lower surface 156 of support plate 152 adjacent corresponding corners 161a-161c thereof. Each caster assembly 162 is identical in structure, and as such, the description hereinafter of caster assembly 162 is intended to describe all of the caster assemblies mounted to lower surface 156 of support plate 152b.

Each caster wheel assembly 162 includes support member 164 having a generally flat upper face 164a and angled lower face 164b. Central aperture 166 extends between upper face 164a and lower face 164b along an axis. Central aperture 166 includes an enlarged diameter portion 168a and a reduced diameter portion 168b. It is contemplated for angled lower face 164b to lie in plane at a predetermined angle to an axis extending perpendicularly through support plate 152. Support member 164 includes first and second side surfaces 171a and 171b, respectively, interconnected by first and second end surfaces 172 and 174, respectively. First side surface 171a includes shoulder 177 formed therein that defines ear 176. Ear 176 projects and includes a central aperture 178 therethrough, for reasons hereinafter described.

Caster wheel assembly 162 further includes caster wheel 181 having an upper surface 182 and a lower surface 184. Upper surface 182 of caster wheel 181 includes a generally cylindrical neck portion 186 projecting therefrom that is dimensioned for receipt within a corresponding central opening 188 in bearing ring 189. Bearing ring 189 facilitates rotation of caster wheel 181 about the axis along which central opening 166 extends through support member 164. Upper surface 182 of caster wheel 181 further includes a generally flat outer ring portion 191 adapted for engagement with lower surface 189b of bearing ring 189. Lower surface 184 of caster wheel 181 includes a generally flat central portion 192 and an angled portion 194 extending radially therefrom. Caster wheel 181 further includes a central aperture having an enlarged diameter portion 196a that communicates with lower surface 184 of caster wheel 181 and a reduced diameter portion 196b that communicates with upper surface 182 of caster wheel 181.

In order to assemble caster wheel assembly 162, upper surface 198a of bearing ring 198 is position against lower face 156 of support plate 152. Alignment disc 201 is positioned within central opening 202 of bearing ring 198. Alignment disc 201 includes a central opening 204 aligned with the corresponding opening 206 in support plate 152. Central aperture 166 in ear 176 of support member 164 is aligned with central opening 204 in alignment disc 201. Thereafter, bracket 208 is positioned such that a first lower portion 208a is seated on shoulder 177 of support member 164 and such that the opening through first portion 208a of bracket 208 is aligned with central aperture 178 through ear 176. Second portion 208b of bracket 208 engages the lower surface 198b of bearing ring 198. As best seen in FIG. 31, bracket 208 is defined by first and second ends 210 and 212, respectively, and first and second sides 214 and 216, respectively. Side 216 of bracket 208 engages recessed wall 218 in first side surface 171a to prevent movement of support member 164 with respect to bracket 208. It can be appreciated that first and second portions 208a and 208b, respectively, of bracket 208 are separated by vertical sidewall 220 of a height generally equal to the thickness of ear 176. Screw 222 is inserted through an opening in washer 224; through central aperature 178 in ear 176; through central opening 204 in alignment disc 201 and into opening 206 in support plate 152.

In order to interconnect caster wheel 181 to support member 164, upper surface 189a of bearing ring 189 is positioned against lower surface 164b of support member 164 and neck portion 186 of caster wheel 181 is inserted into central opening 188 in bearing ring 189. As described, the central aperture of caster wheel 181 and the central aperture 166 through support member 164 are co-axial. Tubular bushing 226 is inserted into a reduced diameter portion 168b of the central aperture through caster wheel 181 and into enlarged diameter portion 168a of central aperture 166 through support member 164. The shaft of screw 228 extends through bushing 226 and is threaded into the reduced diameter portion 168b of central aperture 166 in support member 164 such that the head of screw 228 becomes seated in enlarged diameter portion 196a of the central aperture extending through caster wheel 181.

As described, support member 164 and bracket 208 are rotatable in unison about the axis defined by the shaft of screw 222. In addition, caster wheel 181 is free rotate about an axis defined by the shaft of screw 228. Once assembled, caster assembly 150 may be mounted to object 230 such an article of furniture, file cabinet, piece of machinery or the like in any conventional manner. As described, it can be appreciated that caster assembly 150 facilitates the movement of the object on a supporting surface to a desired location.

Various modes of carrying out the invention are contemplated as being within the scope of the following claims particularly pointing out and distinctly claiming the subject matter which is regarded as the invention.

I claim:

1. A low profile caster assembly, comprising:
a base having a central axis generally perpendicular to the base; and
a first caster wheel operatively connected to the base and having a first side engageable with a supporting surface and a second side, the first caster wheel rotatable about a first axis;
wherein the first axis is at an acute angle to the central axis.

2. The low profile caster assembly of claim 1 further comprising a first support operatively connected to the base and rotatable about the central axis.

3. The low profile caster assembly of claim 2 wherein the first caster wheel is rotatably connected to the first support.

4. The low profile caster assembly of claim 3 further comprising a second caster wheel operatively connected to the base and having a first side engageable with the supporting surface and a second side, the second caster wheel rotatable about a second axis.

5. The low profile caster assembly of claim 4 wherein the second axis is at an acute angle to the central axis.

6. The low profile caster assembly of claim 5 further comprising a second support operatively connected to the base and rotatable about the central axis.

7. The low profile caster assembly of claim 6 wherein the second caster wheel is rotatably connected to the second support.

8. A low profile caster assembly, comprising:
a generally flat base having a central axis extending generally perpendicular thereto;
a first support operatively connected to the base and rotatable about the central axis; and
a first caster wheel operatively connected to the first support and having a first side engageable with a supporting surface and a second side, the first caster wheel being rotatable about a first axis at a predetermined angle to the central axis.

9. The low profile caster assembly of claim 8 wherein the first axis is generally parallel to the central axis.

10. The low profile caster assembly of claim 8 wherein the first axis is at an acute angle to the central axis.

11. The low profile caster assembly of claim 10 further comprising a second caster wheel operatively connected to the base and having a first side engageable with the supporting surface and a second side.

12. The low profile caster assembly of claim 11 wherein the second caster wheel is rotatable about a second axis, the second axis being at an acute angle to the central axis.

13. The low profile caster assembly of claim 12 further comprising a second support operatively connected to the base and rotatable about the central axis.

14. The low profile caster assembly of claim 13 wherein the second caster wheel is rotatably connected to the second support.

15. A low profile caster assembly, comprising:
a base having a central axis extending generally perpendicular thereto;
a first support is operatively connected to the base, the first support being movable about the central axis along a first predetermined path; and
a first caster wheel operatively connected to the first support and having a first side engageable with a supporting surface and a second side adjacent the first support, the first caster wheel rotatable about a first axis at a predetermined angle to the central axis.

16. The low profile caster assembly of claim 15 wherein the first support has a generally flat first side directed toward the base and second side lying in a plane perpendicular to the first axis, the first axis being at an acute angle to the central axis.

17. The low profile caster assembly of claim 16 further comprising:
a second support operatively connected to the base, the second support being movable about the central axis along a second predetermined path; and
a second caster wheel operatively connected to the second support and having a first side engageable with the supporting surface and a second side adjacent the second support.

18. The low profile caster assembly of claim 17 wherein the second caster wheel is rotatable about a second axis that is at a predetermined angle to the central axis.

19. The low profile caster assembly of claim 18 wherein the second axis is at an acute angle to the central axis.

20. The low profile caster assembly of claim 15 wherein the first side of the first castor wheel has a generally flat central portion having a radially outer periphery and an angled portion extending radially from the outer periphery at an acute angle to the first axis.
